(19) United States
(12) Patent Application Publication
(10) Pub. No.: US 2008/0298592 A1
(43) Pub. Date: Dec. 4, 2008

(54) TECHNIQUE FOR CHANGING GROUP MEMBER REACHABILITY INFORMATION

(76) Inventors: Mohamed Khalid, Cary, NC (US); Aamer S. Akhter, Cary, NC (US); Rajiv Asati, Morrisville, NC (US); Brian E. Weis, San Jose, CA (US)

Correspondence Address: KRAGULJAC & KALNAY, 4700 ROCKSIDE ROAD, SUMMIT ONE, SUITE 510, INDEPENDENCE, OH, 44131, US

(21) Appl. No.: 11/754,780

(22) Filed: May 29, 2007

(51) Int. Cl. H04L 9/12

(52) U.S. Cl. 380/278

(57) ABSTRACT

In one embodiment, a technique for updating an address associated with a first entity in a communications network with a second entity in the communications network wherein the address is used to forward information to the first entity from the second entity. The first entity registers a first address associated with the first entity with the second entity. The first entity determines that a second address associated with the first entity is to be used instead of the first address to communicate with the first entity. The first entity generates an update message containing the second address, the update message obviating having to register the second address with the second entity. The first entity forwards the update message to the second entity to cause the second entity to use the second address instead of the first address to forward information to the first entity.

### BACKGROUND

A communication network is a geographically distributed collection of interconnected communication links used to transport data between nodes, such as computers. Many types of communication networks exist, with the types ranging from local area networks (LANs) to wide area networks (WANs). The nodes typically communicate by exchanging discrete packets or messages of data according to pre-defined protocols. In this context, a protocol consists of a set of rules defining how the nodes interact with each other.

Some communication networks employ virtual private networks (VPNs) to confidentially communicate information (data) between nodes over a publicly accessible network. Here, the VPN may be thought of as a private network that exists “on top of” the publicly accessible network. Confidentiality of information carried in the VPN may be maintained using various secure protocols. An example of a suite of secure protocols that may be used is the Internet Protocol Security (IPSec) protocol suite.

IPSec includes protocols for securing communications by encrypting and/or authenticating packets in a data stream. In addition, the IPSec protocol suite includes protocols for cryptographic key establishment and management.

IPSec incorporates various functions for accommodating the secure exchange of information between nodes. These functions include an authentication-only function referred to as an Authentication Header (AH), a combined authentication/encryption function often called Encapsulating Security Payload (ESP) and a key exchange function. For VPNs, both authentication and encryption are generally desired, because it is important for both to (1) assure that unauthorized users do not penetrate the VPN and (2) assure that eavesdroppers cannot read messages sent over the VPN. Thus, most VPN implementations are likely to use ESP rather than AH.

In IPSec keying information (e.g., encryption keys) is used to encrypt and decrypt information exchanged between entities nodes. The keying information may be established and maintained either manually or automatically. In a manual-keyed system, keys are generated and configured manually by, for example, a system administrator. Here, the system administrator may manually configure each node with its own key and with the keys of other communicating systems. This technique may be practical for small, relatively static environments, however, it may prove to be quite cumbersome in large dynamic environments. In an automated-keyed system, encryption keys are typically automatically generated “on demand” and distributed to nodes using various protocols. Automatic generation and distribution of keys facilitates the use of encryption keys in a large distributed system with an evolving configuration. An automated-keyed system is generally more flexible than a manual-keyed system, however, an automated-keyed system often requires more effort to configure and more software. It is for this reason that many smaller installations are likely to opt for manual-key management.

An automated-key management protocol that is commonly used in automated-keyed systems is the well-known Internet Key Exchange (IKE) protocol. IKE provides a standardized method for dynamically authenticating IPSec entities, negotiating security services, and generating shared keys. IKE has evolved from many different protocols and can be thought of as having various distinct capabilities.

One of these capabilities is based on the Internet Security Association and Key Management Protocol (ISAKMP). ISAKMP provides a framework for Internet key management and provides specific protocol support, including formats, for negotiation of security attributes. ISAKMP by itself does not dictate a specific key exchange algorithm, rather, ISAKMP comprises a set of message types that enable the use of a variety of key exchange algorithms.

IKE implementations often employ a key exchange algorithm that is based on the use of the well-known Diffie-Hellman algorithm with added security. In particular, Diffie-Hellman alone does not authenticate users that are exchanging keys, thus, making the algorithm vulnerable to impersonation. To obviate this shortcoming, IKE implementations often include mechanisms to not only exchange keys using Diffie-Hellman but also authenticate users that are exchanging the keys.

An important concept that appears in both the authentication and confidentiality mechanisms for IPSec is the Security Association (SA). Authentication mechanisms often utilize authentication SAs. An authentication SA is a logical connection between peers that affords security services to the traffic carried on it. The traffic carried on the authentication SA typically includes authentication related information. An authentication SA may be uniquely identified by several parameters which may include, for example, an initiator cookie, responder cookie, a local source address and a destination address.

Often peers establish authentication SAs to accommodate the exchange of information associated with the security services. For example, a group member in a VPN may establish an authentication SA between it and a key server in order to send certain authentication related information (e.g., registration information, authentication information, etc.) to the server. Likewise, the key server may establish an authentication SA between it and the group member in order to send certain authentication related information, such as keying information, shared secret information and the like, to the group member.

Confidentiality mechanisms often utilize confidentiality SAs. A confidentiality SA is a logical connection between a sender and a receiver that affords security services to the traffic carried on it. Security services are typically afforded with the use of AH or ESP, but not both. A confidentiality SA may be uniquely identified by three parameters which include a Security Parameters Index (SPI), a destination address and a security protocol identifier. The SPI assigns a bit string to the SA that has local significance only. The SPI is typically an index (e.g., a pointer) that is used to distinguish among various SAs that are associated with the same destination. The SPI is typically carried in AH and ESP headers to enable a receiving system to select an SA under which a received packet may be processed. The destination address is an address of the destination endpoint of the SA which may be one or more end-user systems or other network systems, such as firewalls or routers. The security protocol identifier indicates whether the association is an AH or ESP security association.

Information associated with an SA may be maintained in an entry contained in a SA database (SAD). The entry may include the above information as well as additional information associated with the SA that is used to maintain a secure connection between a sender and a receiver and process information (e.g., packets) exchanged between the sender and receiver over the SA. This additional information may include, for example, data encryption algorithms, encryption keys, initialization vectors, digital certificates, destination addresses and the like.

Enterprises have been rapidly deploying VPN networks using site-to-site models, such as Dynamic Multipoint VPN (DMVPN) or Global Key VPN (GKVPN, also referred to as Group Key VPN) technologies. The GKVPN framework is typically implemented in the form of secured multicast or Dynamic Group VPN (DGVPN) technologies. Generally, such VPN architectures include a key server that manages the deployment of group keys (e.g., re-key data) within the VPN to authorized VPN participants, or group members. With respect to keys that are unique between two peers, GKVPN allows the use of a group key such that all members share the same key. This shared key obviates having to establish a per-peer IKE relationship for the generation of keys. As such, key server protocols provide for various means of updating and distributing group keys within a dynamic VPN network.

### BRIEF DESCRIPTION OF THE DRAWINGS

Objects, features and advantages of the invention will be apparent from the following more particular description of preferred embodiments of the techniques, as illustrated in the accompanying drawings in which like reference characters refer to the same parts throughout the different views. The drawings are not necessarily to scale, with emphasis instead being placed on illustrating embodiments, principles and concepts of the techniques.

FIG. 1 is a block diagram of an example of a communications network that may be used with the invention.

FIG. 2 is a partial block diagram of an example of a group member node that may be used with the invention.

FIG. 3 is a partial block diagram of an example of a key server node that may be used with the invention.

FIG. 4 illustrates an example of a group member state database that may be used with the invention.

FIG. 5 illustrates an example of an update message that may be used with the invention.

FIG. 6 illustrates an example of a dialog that may be used to change reachability information associated with a group member with a key server in accordance with an embodiment of the invention.

FIGS. 7A-C are a flow chart of a sequence of steps that may be used to change reachability information associated with a first entity in a communications network with a second entity in the communications network in accordance with an embodiment of the invention.

### DESCRIPTION OF EXAMPLE EMBODIMENTS

### Overview

A node that participates as a group member (GM) in a GDOI-based virtual private network (VPN) typically registers with a key server that manages encryption keys used by the GMs to encrypt and decrypt information exchanged between the members. In a typical arrangement, the node registers with the key server. This registration may include forwarding an address associated with the node to the key server. The address may be used by the key server to address messages to the node. In addition, the node may forward a group identifier (ID) associated with a VPN group to which the node belongs. The key server, in turn, may authenticate the node, establish an authentication security association (SA) with the node and forward encryption/decryption key information associated with the group to the node. Information associated with the authentication SA, such as the address of the node as well as encryption/decryption key information, may be maintained by the key server in an entry contained in an SA database (SAD).

Periodically, the key server may generate a new key for the group and distribute the new key information to members of the group. The key server may distribute the new key by forwarding individual messages (e.g., re-key messages) containing the new key to each member in the group.

In some circumstances, an address associated with a member of a VPN group may change. For example, the member may be mobile and move from a one sub-network to another. As the member enters the other sub-network, a new address may be assigned to the member to enable it to communicate in the sub-network. Assigning the new address to the member, however, may cause the member to suddenly become isolated and not receive re-key messages from the key server.

With the current technology, this situation may be obviated by registering the new address with the key server. However, registration typically causes a new additional authentication SA to be established for the member as well as may cause a new additional entry in the SAD to be generated to support the new authentication SA. The old SA and the SAD entry associated with the old SA may linger for some time after the new SA is established before they are reclaimed, thus, consuming valuable resources that may be better used elsewhere. In addition, the registration process may involve the exchange of many messages between the group member and the key server which may result in an undesired consumption of processing resources and time, and may cause additional network traffic which may further consume valuable resources.

The invention overcomes such deficiencies by allowing reachability information (e.g., an address) associated with a first entity (e.g., a group member node) in a communications network to be updated at a second entity (e.g., a key server) in the network without requiring the first entity to go through the previously described registration process to cause the updated reachability information to be used by the second entity to forward information (e.g., re-key information) to the first entity.

In an embodiment of the invention, a first entity registers a first address with a second entity that a second entity may use to forward information, such as keying information, to the first entity. The first entity may then provide a second address to the second entity. The second entity associates the first entity with the second address and then subsequently forwards information to the first entity using the second address.

### DESCRIPTION

Embodiments of the techniques described herein are described as using various well-known protocols including the Group Domain of Interpretation (GDOI) protocol and the Dynamic Host Configuration Protocol (DHCP). A version of GDOI that may be used with the techniques described herein is described in M. Baugher et al, “The Group Domain of Interpretation”, Request For Comments (RFC) 3547, July 2003 which is available from the Internet Engineering Task Force (IETF). A version of DHCP that may be used with the techniques described herein is described in R. Droms, “Dynamic Host Configuration Protocol”, RFC 2131, March 1997 which is also available from the IETF.

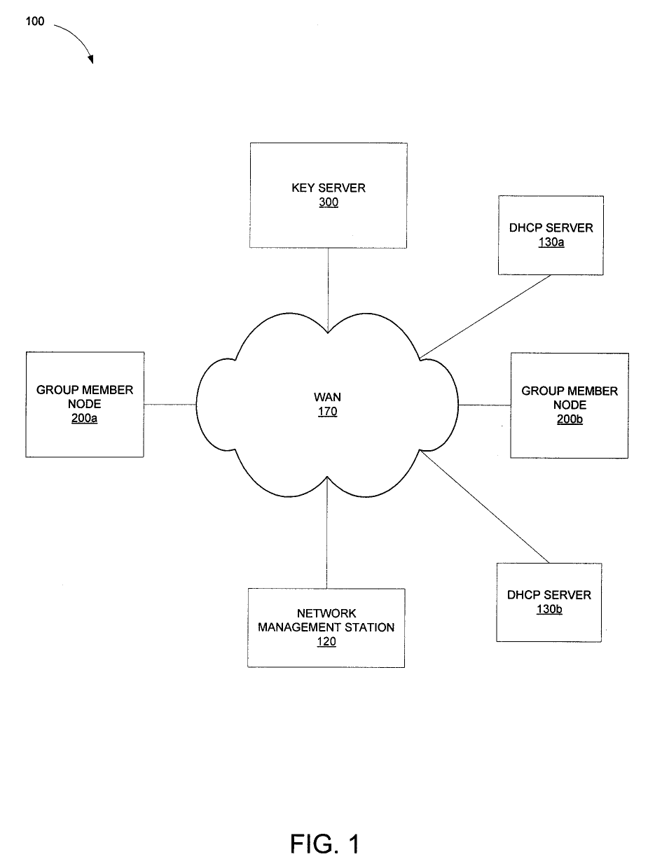

FIG. 1 is a block diagram of an example of a communications network 100 that may be used with the techniques described herein. Network 100 comprises a collection of nodes including group member nodes 200a-b, key server node 300, network management station 120 and DHCP servers 130a-b coupled to a wide-area network (WAN) 170 to form an internetwork of nodes. These internetworked nodes communicate by exchanging information (e.g., data packets) according to a pre-defined set of network protocols and mechanisms, such as the Transmission Control Protocol/Internet Protocol (TCP/IP), GDOI, DHCP and so on. A protocol as used herein relates to a set of rules defining how nodes in a communications network interact with each other.

DHCP servers 130a-b are configured to distribute addresses (e.g., IP addresses) to nodes contained in the network 100. Each DHCP server 130 is illustratively configured to distribute addresses for a particular sub-network contained in network 100. For example, DHCP server 130a may be configured to distribute addresses to nodes in a first sub-network while DHCP server 130b may be configured to distribute addresses to nodes in a second sub-network. Network management station 120 is configured to manage resources in the network 100. These resources may include various nodes in the network, such as group member nodes 200.

The group member nodes 200 are nodes that belong to a group which may be a GDOI-based VPN group. Members of a particular GDOI-based VPN group share keying information (e.g., public encryption keys) that may be used to encrypt and decrypt information that is exchanged between the members of the group. Keying information is distributed to members of a group in accordance with the GDOI protocol.

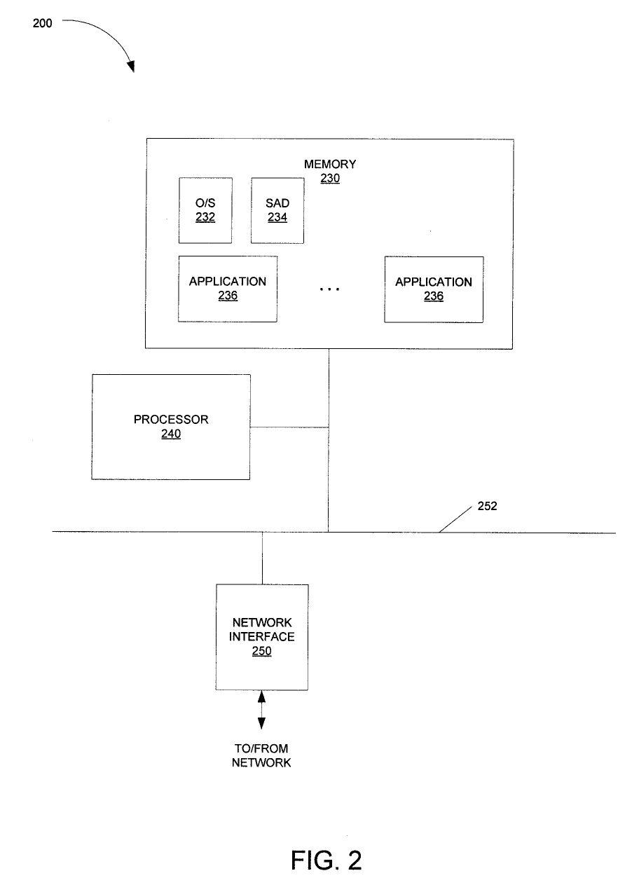

FIG. 2 is a partial block diagram of an example of a group member node 200 that may be used with the invention. Node 200 comprises a processor 240 coupled to memory 230 and interface 250 via a bus 252. It should be noted that node 200 is one example of a node that may be used with the invention. The invention may also be used with other nodes of varying types and complexities. Node 200 may be a personal computer (PC), such as a Dell Inspiron personal computer available from Dell Incorporated, Round Rock, Tex. Alternatively, node 200 may be a router, such as an edge router. An example of a router that may be used with the techniques described herein is the Cisco 7600 Series router available from Cisco Systems Incorporated, San Jose, Calif.

The processor 240 is a central processing unit (CPU) that comprises processing circuitry for executing instructions and manipulating data (such as that for implementing aspects of the invention) contained in memory 230. Bus 252 is a point-to-point interconnect bus configured to couple various entities contained in node 200 including the processor 240, memory 230 and interface 250, and enable data and signals to be transferred between these entities.

The network interface 250 is coupled to the network 100 and is configured to connect (interface) the node 200 with the network 100 and enable information (e.g., data packets) to be transferred between the node 200 and other nodes in network 100 using various protocols such as, for example, the Ethernet protocol. To that end, network interface 250 comprises interface circuitry that may incorporate the signal, electrical and mechanical characteristics and interchange circuits needed to interface with the physical media and protocols running over that media.

Memory 230 is a computer-readable medium implemented as a random access memory (RAM) data storage comprising RAM devices, such as dynamic RAM (DRAM) devices. Memory 230 is configured to hold various software and data structures including operating system (OS) 232, security association database (SAD) 234 and one or more applications 236.

OS 232 is an operating system comprising computer-executable instructions and data for implementing various operating system functions, such as scheduling applications 236 for execution on the processor 240. Moreover, OS 232 may contain computer-executable instructions and data structures that implement aspects of the invention.

SAD 234 is a security association database configured to hold information about security associations maintained by node 200. This information may include addresses associated with destinations (e.g., other nodes in network 100), security parameter indexes (SPIs), security protocol identifiers, encryption algorithms, keying information (e.g., cryptographic keys), initialization vectors, digital certificates and the like. The applications 236 are software applications that execute under control of the OS 232. The applications 236 contain computer-executable instructions and data that may include computer-executable instructions and data that implement aspects of the invention.

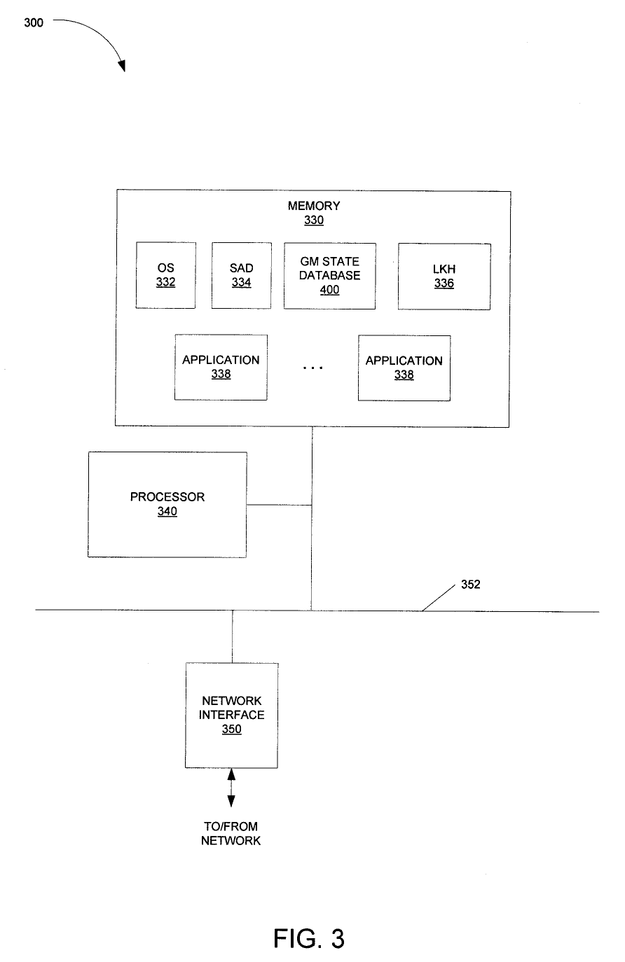

FIG. 3 is a block diagram of an example of a key server node 300 that may be used with the invention. Node 300 comprises a processor 340 coupled to memory 330 and a network interface 350 via a bus 352. It should be noted that node 300 is one example of a node that may be used with the invention. The invention may also be used with other nodes of varying types and complexities. Node 300 may be a server, such as the Dell PowerEdge™ server available from Dell Incorporated. Alternatively, node 300 may be a router, such as the above-described Cisco 7600 series router.

The processor 340 is a CPU that comprises processing circuitry for executing instructions and manipulating data contained in memory 330. The bus 352 is a point-to-point interconnect bus configured to couple various entities contained in node 300 including the processor 340, memory 330 and interface 350, and enable data and signals to be transferred between these entities.

The network interface 350 is coupled to network 100 and is configured to connect (interface) the node 300 with the network 100 and enable information (e.g., data packets) to be transferred between the node 300 and other nodes in the network 100 using various protocols such as, for example, Ethernet, Frame Relay (FR), Asynchronous Transfer Mode (ATM) and the like. To that end, interface 350 comprises interface circuitry that incorporates the signal, electrical and mechanical characteristics and interchange circuits needed to interface with the physical media and protocols running over that media.

Memory 330 is a computer-readable medium implemented as a RAM data storage comprising RAM devices, such as DRAM devices. Memory 330 is configured to hold various software and data structures including operating system (OS) 332, SAD 334, group member (GM) state database 400, logical key hierarchy (LKH) 336 and one or more applications 338.

OS 332 is an operating system comprising computer-executable instructions and data for implementing various operating system functions, such as scheduling applications 338 for execution on the processor 340. Moreover, OS 332 may contain computer-executable instructions and data structures for implementing aspects of the invention. SAD 334 is a security association database that is configured to hold information about security associations maintained by node 300. This information may include addresses associated with destinations (e.g., other nodes in network 100), SPIs, security protocol identifiers, encryption algorithms, keying information (e.g., cryptographic keys), initialization vectors, digital certificates and the like. LKH 336 is a data structure that contains a conventional logical key hierarchy of encryption key information that is associated with nodes in the network 100. The applications 338 are software applications that execute under control of the OS 332. The applications 338 contain computer-executable instructions and data that may include computer-executable instructions and data that implement aspects of the invention.

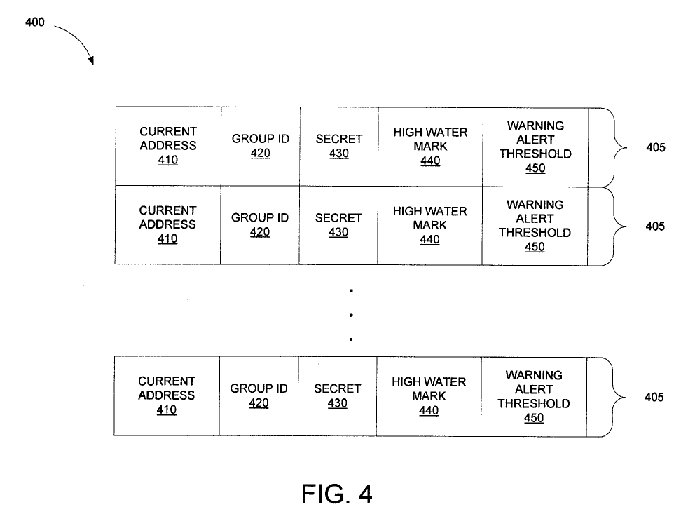

The GM state database 400 is a data structure that comprises information about group members (e.g., nodes 200a-b) in network 100. FIG. 4 is an illustration of a GM state database 400 that may be used with the invention. Database 400 is organized as a table comprising one or more entries 405. Each entry 405 is associated with a group member and contains a current address field 410, a group identifier (ID) field 420, a secret field 430, a high water mark field 440 and a warning alert threshold field 450. It should be noted that each entry 405 may contain other fields that hold information associated with the group member including, for example, a pointer to an entry in the SAD 334 of a security association that is associated with the group member.

The current address field 410 holds a value that represents an address (e.g., an IP address) associated with the group member. This address may be distributed to the group member via a DHCP server 130. The address may be used by nodes in the network 100 to address messages (e.g., data packets) to the group member. The group ID field 420 holds a value that represents a group ID associated with a group (e.g., a GDOI-based VPN group) to which the group member belongs.

The secret field 430 holds a value that represents a secret that is, e.g., shared between the group member and the key server 300. The key server 300 may use this secret to authenticate messages originated by the group member. The secret may be a secret key, a public key, an encryption algorithm, a private key and the like. For example, the secret field 430 may hold a secret key that may be used in combination with a message authentication code algorithm to generate a message authentication code (MAC). The MAC may be used by a key server to authenticate messages sent by the group member.

The high water mark field 440 holds a value that represents a high water mark for update messages received from the group member. As will be described further below, this value may be used to determine if the group member is sending too many update messages to the key server 300 and if so take appropriate action. For example, if the number of update messages received from the group member (within a certain period of time) exceeds the high water mark, the key server may conclude the group member is “misbehaving” and “eject” the group member from the group.

The warning alert threshold field 450 holds a value that represents a warning threshold for update messages received from the group member. Server 300 may use the warning alert threshold to determine if the group member is sending a certain level of update messages within a certain period of time and if so take appropriate action. For example, if the key server 300 receives a number of messages from the group member (within a certain period of time) that exceeds the warning alert threshold 450, the key server 300 may issue a warning message to the various recipients in network 100, such as the group member and/or network management station 120, to notify these entities that the group member is sending too many update messages.

Operationally, a group member node's processor 240 generates messages that are destined for the key server 300. These messages are held in memory 230 and transferred via bus 252 to the network interface 250. The network interface 250 transfers the messages onto the network 100 which forwards the messages to the key server 300. The key server's network interface 350 acquires (receives) the messages and transfers them via the bus 352 to memory 330. The processor 340 processes the messages. This processing may include updating various data structures, such as GM state database 400 and SAD 334.

Messages generated at the key server 300 and destined for a group member node 200 are generated by the key server's processor 340 and placed in memory 330. The messages are transferred from the memory 330 to the network interface 350 via bus 352. Network interface 350 transfers the messages onto the network 100 which forwards the messages to the group member node 200. The group member node 200 acquires (receives) the messages at its network interface 250 which transfers the messages via bus 252 to memory 230 where the processor 240 processes the messages. This processing may include updating various data structures, such as SAD 234.

It should be noted that functions performed by the nodes 200, 300 including functions for implementing aspects of the invention, may be implemented in whole or in part using some combination of hardware and/or software including firmware. It should be further noted that computer-executable instructions and/or computer data for implementing aspects of the invention may be stored in various computer-readable mediums, such as volatile memories, non-volatile memories, flash memories, removable disks, non-removable disks and the like. In addition, it should be noted that various electromagnetic signals, such as wireless signals, electrical signals carried over a wire, optical signals carried over optical fiber and the like may be encoded to carry computer-executable instructions and/or computer data for implementing aspects of the invention on, e.g., a communications network.

As will be described further below, in an embodiment of the invention, a group member node 200 acquires a first address and registers it with the key server 300. The first address is used by the key server 300 to forward information, such as re-keying information, to the group member node 200. The group member node 200 may later acquire a second address that replaces the first address. The group member node 200 generates an update message and forwards the update message to the key server 300. The receipt of the update message causes the key server 300, when forwarding information (e.g., re-keying information) to the group member 200, to use the second address instead of the first address. No additional registration process is required by the key server for the switch to the second address.

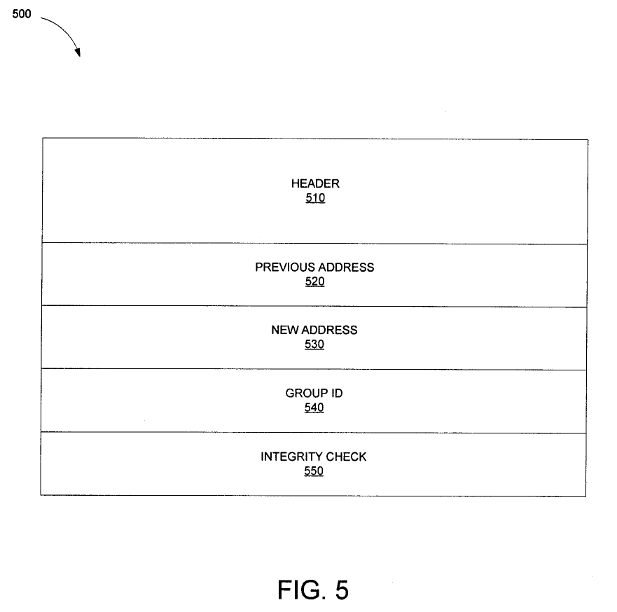

FIG. 5 is an example of an update message 500 that may be used by a group member to update an address with the key server 300. Message 500 comprises a header field 510, a previous address field 520, a new address field 530, a group identifier (ID) field 540 and an integrity check field 550. The header field 520 holds header information that may be used in forwarding the message to a destination (e.g., server 300) in a communications network, such as network 100. This information may include, for example, an address that identifies the source of the message and an address that identifies the destination.

The previous address field 520 holds a value that represents a previous address associated with the group member and previously registered with the key server 300. The new address field 530 holds a value that represents a new address associated with the group member. This address replaces the previous address as an address that may be used by the key server 300 to forward messages (e.g., re-keying messages) to the group member. The group ID field 540 holds a group ID associated with the group member. The group ID is an identifier that identifies a group (e.g., GDOI-based VPN group) to which the group member belongs. The integrity check field 550 holds a value that may be used by the key server 300 to authenticate the message 500. The value may be derived from a secret that is shared between the group member and the key server 300.

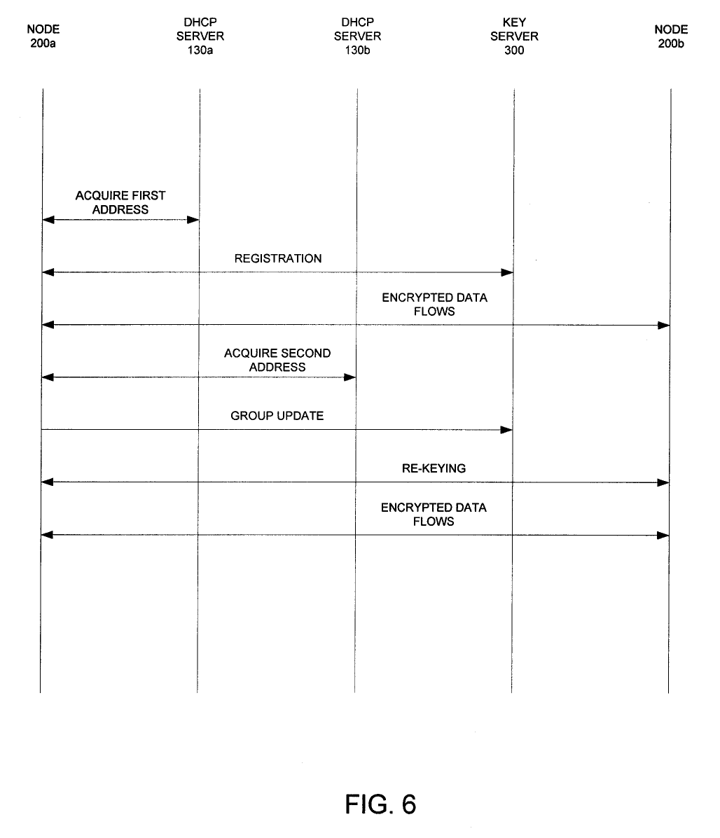

FIG. 6 illustrates an example of a dialog that includes updating a group member's address with a key server in accordance with an example embodiment of the invention. Referring to FIGS. 1 and 6, in the example embodiment GM node 200a and GM node 200b are members of a particular group and, node 200a is initially in a first sub-network that is serviced by DHCP server 130a.

Node 200a acquires a first address from DHCP server 130a that may be used to address messages to node 200a. Node 200a registers the first address with the key server 300 which may involve exchanging several messages between node 200a and server 300. These messages may include keying information (e.g., a shared group encryption key) that node 200a may use to encrypt and decrypt messages exchanged with node 200b on various encrypted data flows. In addition, server 300 may establish an authentication SA between node 200a and server 300, generate an entry in SAD 334 for the SA, associate the first address with the SA in the SAD entry, generate an entry 405 in the GM state database 400 for node 200a and place the first address in the entry's current address field 410.

Likewise, node 200a may establish an entry in its SAD 234 for the SA and associate the first address with the SA in the SAD entry to cause the first address to be used when communicating with the server 300 using the SA. Moreover, node 200a may associate the keying information with the SA in the SAD entry to cause information transferred to server 300 to be encrypted using the keying information.

In addition to the authentication SA between node 200a and server 300, node 200a may establish a local group confidentiality SA that it uses to communicate with other group members (e.g., node 200b), generate an entry in SAD 234 for the SA and associate the first address with this SA, as described above, so that the first address is used when communicating with other members of the group. Likewise, node 200a may associate the keying information with the local group SA in the local group SA's SAD entry to cause information transferred from node 200a to members of the group to be encrypted using the keying information.

In an embodiment, node 200a is mobile. Mobile node 200a may leave the first sub-network and roam into a second sub-network serviced by DHCP server 130b. Node 200a acquires a second address from DHCP server 130b that replaces the first address. Node 200a notifies the key server 300 of the address change by generating a group update message 500 that includes the first address in the previous address field 520 and the second address in the new address field 530, and forwarding the group update message to the key server 300. In addition, node 200a associates the second address with its local group SA and the SA between node 200 and the server 300 by replacing the first address with the second address in entries contained in the SAD 234 for the SAs to cause the second address to be used instead of the first address when communicating using these SAs. Note that since node 200a is not required to register the second address with server 300 as it did with the first address, node 200a may then immediately begin utilizing the second address to communicate with other nodes (e.g., server 300, node 200b) in the network.

The key server 300 acquires the update message and in response to the message associates the second address with the authentication SA to cause the second address rather than the first address to be used to transfer information to node 200a. This association may be made by replacing the first address with the second address in the SAD entry for the authentication SA in SAD 334 to cause the second address to be used when using the authentication SA. In addition, server 300 may generate new keying information (re-keying information) for the group that includes new encryption keys that are used to encrypt/decrypt information exchanged between the server and the GM nodes 200. The server 300 forwards the re-keying information to node 200a using the second address. The server 300 may forward the re-keying information to node 200a by (1) generating a re-key message containing the re-keying information, (2) specifying the second address as a destination for the re-key message (e.g., placing the second address in a destination address field contained in the message) and (3) forwarding the re-key message onto the network 100. Nodes in a path between server 300 and node 200a in the network 100 may use the second address contained in the message to forward the message to node 200a.

Node 200a acquires the re-key message and in response to the message associates the re-keying information with the authentication SA between server 300 and the node 200a by, e.g., replacing the keying information contained in the SA's SAD entry with the re-keying information. In addition, node 200a may update the keying information contained in the SAD entry associated with the local group SA with the re-keying information. Node 200a may then begin using the new keying information to encrypt and decrypt messages exchanged between it and other nodes in the network on various encrypted data flows associated with these SAs when, e.g., the previous keying information expires.

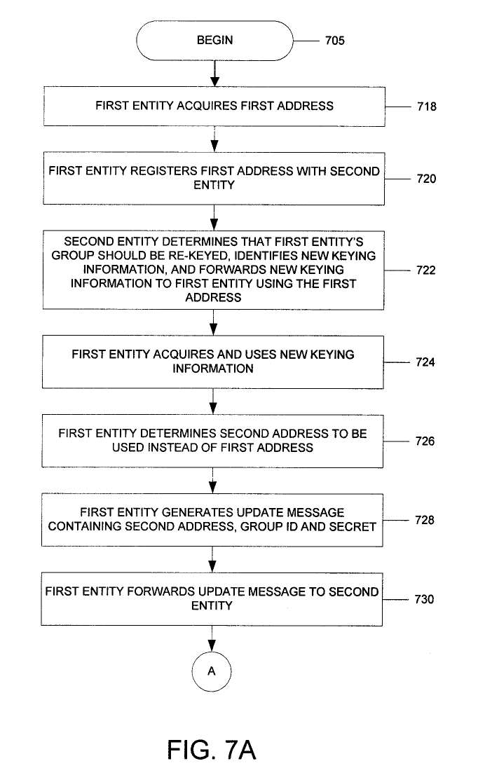

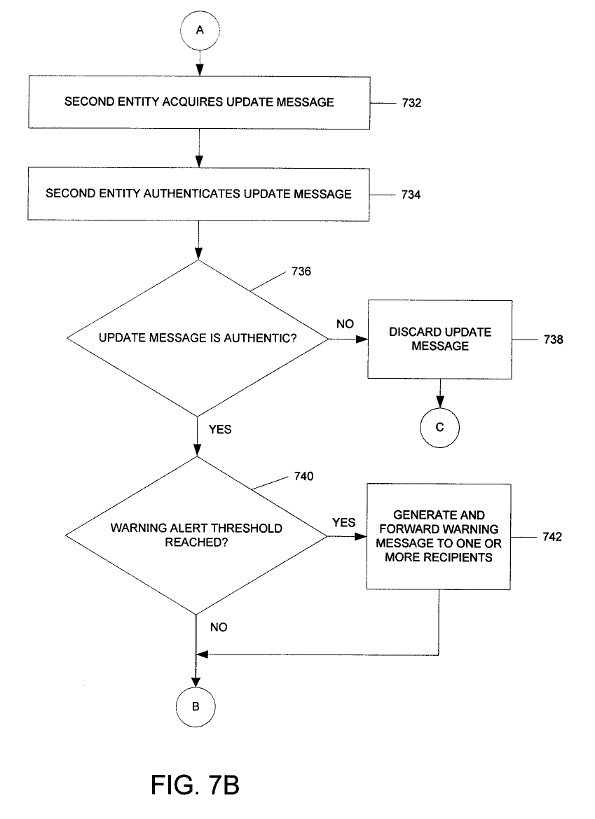

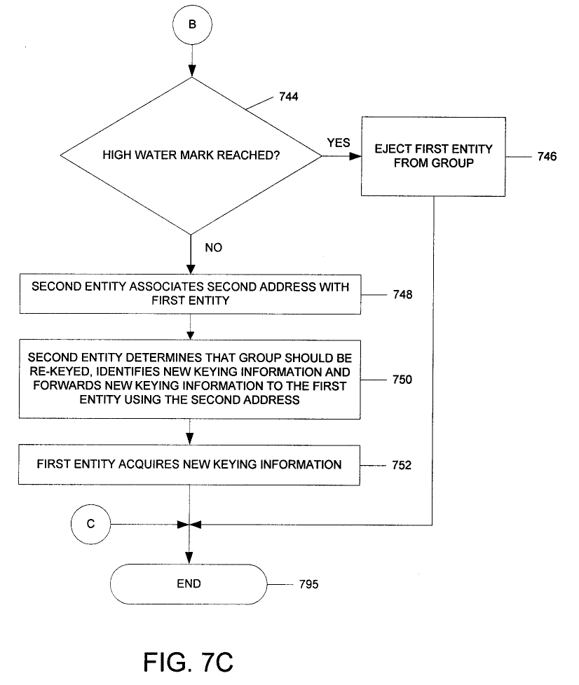

FIGS. 7A-C are a flow chart of a sequence of steps that may be used to update an address associated with a first entity (e.g., a group member) in a communications network with a second entity (e.g., a key server) in the communications network in accordance with an embodiment of the invention. The sequence begins at step 705 and proceeds to step 718 where the first entity acquires a first address that is used to forward information to the first entity. In one embodiment, the first address is associated with a particular sub-network and acquired, for example, in a data packet sent by a server, such as a DHCP server. In another embodiment, the first address is preconfigured at the first entity by, for example, a system administrator.

At step 720, the first entity registers the first address with the second entity to cause the second entity to use the first address to forward information (e.g., re-keying information) to the first entity using the first address. This registration may involve generating a registration message containing the first address and a group identifier (ID) of a group associated with the first entity and forwarding the registration message to the second entity. The group may be a VPN group that the first entity is to join.

The second entity acquires the registration message containing the first address and group ID and associates the first entity with the first address. This association may include generating an entry 405 in data structure 400 for the first entity and placing the first address and group ID in the current address field 410 and the group ID field 420 of the entry 405, respectively. Moreover, a high water mark and warning alert threshold may be identified for the first entity and placed in the entry's high water mark 440 and warning alert threshold 450 fields, respectively.

In addition, the registration may involve identifying keying information and a secret for the first entity, and forwarding the identified keying information and secret to the first entity in a reply message. The identified keying information may be identified from information contained in LKH 336. The secret may be a secret, as described above, that is shared between the first entity and the second entity. The secret may be generated by the second entity, preconfigured at the second entity by, e.g., a system administrator, or otherwise acquired by the second entity. The secret may be maintained by the second entity in the secret field 430 of an entry 405 in database 400 that is associated with the first entity.

Also, the registration may involve (1) establishing an authentication SA at the second entity that may be used with communicating with the first entity and (2) associating the first address and keying information with the SA, as described above, to cause the first address and keying information to be used when communicating with the first entity using the authentication SA. In addition, the first entity may establish a local group SA that is used to communicate with members of the group and associate the first address and keying information with the local group SA, as described above, to cause the first address and keying information to be used when communicating with group members using the local group SA.

At step 722, the second entity determines that the group associated with the first entity should be re-keyed. Here, the second entity may identify (e.g., generate) new keying (re-keying) information for the group and forward the re-keying information to the first entity using the first address. The re-keying information may be forwarded to the first entity using a re-key message that specifies the first address as a destination for the message. In addition to forwarding the re-keying information to the first entity, the second entity may associate the re-keying information with the authentication SA to cause the new keying information to be used by the second entity when communicating with the first entity using the SA, as described above.

At step 724, the first entity acquires the re-keying information by receiving the re-key message. The first entity may associate the re-keying information with the authentication SA it uses to communicate with the second entity and the local group SA it uses to communicate with group members to cause the re-keying information to be used when communicating with these entities using the SAs.

At step 726, the first entity determines that a second address should be used instead of the first address to communicate with the first entity. In one embodiment, the first entity makes this determination in response to acquiring the second address from another entity in the network, such as a DHCP server. In another embodiment, the first entity is a dual-homed node that has a primary link associated with the first address and a secondary link associated with the second address. In this embodiment, the first entity makes this determination in response to, e.g., switching from the primary link to the secondary link to cause the secondary link to be used for communications with the first entity instead of the primary link.

At step 728, the first entity generates an update message that contains the second address. In addition, the update message may contain a group ID associated with the first entity as well as an integrity check, as described above. Note that the first entity may use the secret shared between the first entity and the second entity to encrypt the update message. If this is the case, the first entity may skip placing the integrity check in the update message. Also note that the update message obviates having to go through the above-described registration process (1) to inform the second entity of the second address and (2) to cause the second entity to use the first address instead of the second address to forward information (e.g., re-keying information) to the first entity.

The first entity may associate the second address with the authentication SA to cause the second address to be used when communicating with the second entity using the authentication SA, as described above. Likewise, the first entity may associate the second address with the local group SA to cause the second address to be used when communicating with group members using the local group SA, as described above.

The first entity forwards the update message to the second entity, at step 730. At step 732 (FIG. 7B), the second entity acquires (receives) the update message. If the update message was encrypted using the shared secret, the second entity may use the shared secret to decrypt the message.

At step 734, the second entity authenticates the update message to ensure the update message was indeed originated by the first entity. The second entity authenticates the message using an integrity check value contained in the message. Here, if the integrity check value is based on a secret that is shared between the first entity and the second entity, the second entity may use the secret to generate a local integrity check value. The second entity may then compare the generated local integrity check value with the integrity check value contained in the update message. If the two values match, the second entity may conclude that the update message is authentic (i.e., the source of the message is indeed the first entity). Otherwise, the second entity may conclude the update message is not authentic.

At step 736, if the update message is not authentic, the sequence proceeds to step 738 where the second entity discards the update message. From step 738, the sequence proceeds to step 795 (FIG. 7C) where the sequence ends. Otherwise, if the update message is authentic, the sequence proceeds to step 740 where the second entity performs a check to determine if a warning alert threshold has been reached. The second entity maintains a tally of the number of update messages received from the first entity within a predetermined period of time. The determination at step 740 may then be made by comparing the tally with the warning alert threshold 450 contained in the first entity's entry 405 to determine if the tally is equal to or greater than the warning alert threshold 450. If so, the second entity concludes that the warning alert threshold has been reached and the sequence proceeds to step 742 where the second entity generates and forwards a warning message to one or more recipients, which may include, e.g., a network management station and/or the first entity. The sequence then proceeds to step 744 (FIG. 7C).

If at step 740 the second entity determines that the warning alert threshold has not been reached, the sequence proceeds to step 744 where the second entity determines if a high water mark has been reached. The second entity determines if the high water mark has been reached by comparing the tally with the high water mark 440 contained in the first entity's entry 405 and if the tally is equal to or greater than the high water mark 440, the second entity concludes that the high water mark has been reached.

If at step 744, the second entity determines that the high water mark has been reached, the sequence proceeds to step 746 where the second entity ejects the first entity from its group. This may include generating and sending a message to one or more recipients to notify them that the first entity has been ejected. The recipients may include, e.g., a network management station that manages the first entity. From step 746, the sequence proceeds to step 795 where the sequence ends.

If at step 744, the second entity determines that the high water mark has not been reached, the sequence proceeds to step 748 where the second entity associates the second address with the first entity. This association is made by replacing the first address contained in the current address field 410 of the first entity's entry 405 with the second address. In addition, the second entity may update the authentication SA with the second address to cause the second address to be used as a destination address in a message, instead of the first address when communicating with the first entity using the authentication SA, as described above.

At step 750, the second entity determines that the group associated with the first entity is to be re-keyed. The second entity identifies (e.g., generates) re-keying information (e.g., new encryption keys) for the group and forwards the re-keying information to the first entity using the second address. The second entity may associate the re-keying information with the authentication SA to cause the re-keying information to be used when communicating with the first entity using the authentication SA, as described above. The re-keying information may be forwarded to the first entity using a re-key message that specifies the second address as a destination for the message, as described above.

At step 752, the first entity receives the re-keying information. The first entity may associate the re-keying information with the authentication SA to cause the new keying information to be used when communicating with the second entity, as described above. Likewise, the first entity may associate the re-keying information with the local group SA to cause the re-keying information to be used when communicating with the group members, as described above. From step 752, the sequence proceeds to step 795 where the sequence ends.

Following is an example of how the invention may be used in network 100. For example, referring to FIG. 1, in an embodiment, node 200a is a group member of a GDOI-based VPN group that includes node 200b as a group member and needs to register with key server 300 in order to receive keying information that may be used to communicate with node 200b.

Node 200a acquires a first address that may be used to forward information to node 200a (step 718). In the embodiment, node 200a is in a sub-network that is serviced by DHCP server 130a and node 200a acquires the first address from server 130a. Node 200a registers the first address with the key server 300, as described above (step 720). In the embodiment, server 300 establishes an authentication SA with node 200a that server 300 uses to communicate with node 200a, as described above. Also node 200a associates the first address with the authentication SA and establishes a local group SA that node 200a uses to communicate with group members, such as member 200b, as described above.

Eventually, the key server 300 determines that the group should be re-keyed. The key server 300 identifies re-keying information (e.g., new encryption keys) and forwards the re-keying information to node 200a using the first address (step 722). Specifically, the key server 300 identifies the re-keying information and forwards the re-keying information to node 200a in a re-key message addressed to node 200a using the first address, as described above. Node 200a acquires the re-keying information (step 724) and associates the re-keying information with the authentication SA it uses to communicate with server 300 as well as its local SA it uses to communicate with group members so that the re-keying information may be used to encrypt and decrypt information exchanged with the server 300 and other members of the group (e.g., node 200b), respectively, when, e.g., the previous keying information expires.

In the embodiment, node 200a is mobile and roams into a different sub-network which is serviced by DHCP server 130b. Node 200a acquires a new address (second address) from DHCP server 130b which replaces the first address (step 726). Node 200a updates the authentication SA with the second address to cause the second address to be used when communicating with the server 300 using the authentication SA, as described above. In addition, node 200a updates the local group SA with the second address to cause the second address to be used when communicating with the group members using the local group SA, as described above.

Node 200a generates an update message 500 containing the first address in the previous address field 520, the second address in the new address field 530, its group's ID in the group ID field 540 and an integrity check value in the integrity check field 550. In addition, node 200a initializes the header field 510 to cause the message to forwarded to key server 300 (step 728). Node 200a then forwards the update message 500 to key server 300 (step 730).

Key server 300 acquires the update message 500 (step 732) and authenticates the update message using the integrity check value (step 734), as described above. Assuming the message is authentic (step 736), the key server 300 determines if the warning alert threshold has been reached (step 740), as described above. Assuming the warning alert threshold has not been reached, the key server 300 determines if the high water mark has been reached (step 744). Assuming the high water mark has not been reached, the key server 300 associates the second address with node 200a (step 748). Specifically, key server 300 replaces the current address field 410 contained in the entry 405 associated with node 200a with the new address 530 contained in the update message 500. In addition, key server 300 associates the second address with the authentication SA used to communicate with node 200a to cause the second address instead of the first address to be used when communicating with node 200a using the SA, as described above.

Eventually, key server 300 determines that the group should be re-keyed, identifies re-keying information (e.g., new encryption keys), updates the SA and forwards the re-keying information to node 200a using the second address, as described above (step 750). Node 200a receives the re-keying information, updates its SAs and uses the re-keying information to encrypt/decrypt messages when, e.g., the previous keying information expires, as described above.

While the invention have been particularly shown and described with reference to particular aspects, it will be understood by those skilled in the art that various changes in form and details may be made therein without departing from the scope and spirit of the invention encompassed by the appended claims. As such, the foregoing described aspects are not intended to be limiting. Rather, any limitations to the claimed invention are presented in the following claims.

What is claimed is:

1. A method comprising:
registering a first address, associated with a first entity in a communications network, with a second entity in the communications network to cause the second entity to forward keying information to the first entity using the first address;
acquiring a second address;
generating an update message containing the second address; and
forwarding the update message to the second entity to cause the second entity to use the second address instead of the first address to forward keying information to the first entity.

2. A method as defined in claim 1 further comprising:
associating the first address with a security association (SA).

3. A method as defined in claim 2 wherein the SA is an authentication SA.

4. A method as defined in claim 2 further comprising:
associating the second address with the SA.

5. A method as defined in claim 2 further comprising:
acquiring keying information forwarded by the second entity; and
associating the keying information with the SA.

6. A method as defined in claim 1 wherein the first entity is a group member of a Virtual Private Network (VPN) group.

7. A method as defined in claim 1 wherein the second entity is a key server.

8. A method as defined in claim 1 wherein the update message is encrypted.

9. A method as defined in claim 1 wherein the update message contains a secret key.

10. A method comprising:
using a first address, associated with a first entity in a communications network, to forward keying information to the first entity;
acquiring an update message containing a second address associated with the first entity; and
using the second address instead of the first address to forward keying information to the first entity.

11. A method as defined in claim 10 further comprising:
establishing a security association (SA) with the first entity.

12. A method as defined in claim 11 wherein the SA is an authentication SA.

13. A method as defined in claim 10 wherein the first entity is associated with a Virtual Private Network (VPN) group.

14. A method as defined in claim 13 further comprising:
determining if acquiring the update message causes a high water mark to be reached; and
if so, ejecting the first entity from the VPN group.

15. A method as defined in claim 10 further comprising:
determining if acquiring the update message causes a warning alert threshold to be reached; and
if so, forwarding a warning message to a recipient in the communications network.

16. A method as defined in claim 10 further comprising:
authenticating the update message using an integrity check value that is contained in the update message.

17. An apparatus comprising:
a network interface coupled to a communications network; and
a processor configured to:
register a first address, associated with a first entity in the communications network, with a second entity in the communications network to cause the second entity to forward keying information to the first entity using the first address;
acquire a second address;
generate an update message containing the second address; and
forward the update message, via the network interface, to the second entity to cause the second entity to use the second address instead of the first address to forward keying information to the first entity.

18. An apparatus comprising:
a network interface coupled to a communications network; and
a processor configured to:
use a first address, associated with a first entity in the communications network, to forward keying information, via the network interface, to the first entity;
acquire an update message containing a second address associated with the first entity; and
use the second address instead of the first address to forward keying information, via the network interface, to the first entity.

19. An apparatus comprising:
means for registering a first address, associated with a first entity in a communications network, with a second entity in the communications network to cause the second entity to forward keying information to the first entity using the first address;
means for acquiring a second address;
means for generating an update message containing the second address; and
means for forwarding the update message to the second entity to cause the second entity to use the second address instead of the first address to forward keying information to the first entity.

20. An apparatus comprising:
means for using a first address, associated with a first entity in a communications network, to forward keying information to the first entity;
means for acquiring an update message containing a second address associated with the first entity; and
means for using the second address instead of the first address to forward keying information to the first entity.

21. Logic encoded on one or more tangible computer readable media for execution, and when executed, operable to:
register a first address, associated with a first entity in a communications network, with a second entity in the communications network to cause the second entity to forward keying information to the first entity using the first address;
acquire a second address;
generate an update message containing the second address; and
forward the update message to the second entity to cause the second entity to use the second address instead of the first address to forward keying information to the first entity.

22. Logic encoded on one or more tangible computer readable media for execution, and when executed, operable to:
use a first address, associated with a first entity in a communications network, to forward keying information to the first entity;
acquire an update message containing a second address associated with the first entity; and
use the second address instead of the first address to forward keying information to the first entity.
